(19) United States
(12) Patent Application Publication
(10) Pub. No.: US 2014/0234549 A1
(43) Pub. Date: Aug. 21, 2014

(54) THERMALLY SPRAYED WEAR-RESISTANT PISTON RING COATING

(71) Applicant: Mahle International GmbH, Stuttgart (DE)

(72) Inventors: THOMAS J. SMITH, Muskegon, MI (US); Thomas Stong, Kent City, MI (US)

(21) Appl. No.: 13/840,976

(22) Filed: Mar. 15, 2013

Related U.S. Application Data
(60) Provisional application No. 61/765,242, filed on Feb. 15, 2013.

(51) Int. Cl. F16J 9/22

(52) U.S. Cl. CPC F16J 9/22
USPC 427/456

(57) ABSTRACT

Some embodiments comprise systems, methods, compositions, and apparatus including, but not limited to, thermally sprayed titanium-nitride ceramic particles encapsulated in one of several pure metals or metallic alloys; for producing a high wear-resistant coating on the contacting friction surfaces of machined component parts, including among them, piston rings, piston connecting rods and cylinder liners.

### CROSS-REFERENCE TO RELATED APPLICATIONS

This application claims priority to U.S. Provisional Patent Application Ser. No. 61/765,242, filed Feb. 15, 2013, which is hereby incorporated herein in full.

### FIELD OF THE INVENTION

The present invention relates to the improvement of wear resistance in mechanical systems and apparatus.

### BACKGROUND

It is known that moving parts in mechanical systems can be subject to frictional forces. As a nonlimiting example, during normal engine operation, the piston rings in internal combustion engines are subjected to frictional forces. The face of the piston ring is always in direct contact with the cylinder wall. During normal engine operation, the piston movement within the cylinder occasionally removes the lubricating film from the cylinder wall. The removal of the lubricating oil film results in detrimental metal to metal contact and accelerated ring face wear.

As internal combustion engines achieve increasingly higher performance, higher power, and higher operating stresses, the piston rings must have excellent wear and scuff resistance. A commonly known problem with piston rings is that they are not sufficiently resistant to wear. Increased wear resistance has been achieved by coating the piston ring with a material known to possess improved wear resistance as compared to the metal usually used as ring material. Some typical coatings include; nitrides, carbides, chromium, and ceramics and cermets. However, most and best known processes for applying these coatings are expensive and time-consuming.

In current applications, the outer peripheral surfaces of piston rings made of cast iron or steel are often surface-treated with materials such as hard chromium plating, chromium carbide cermets, chromium nitride, gas nitriding, and thin layers such as DLC (diamond like carbon) and titanium nitride via PVD. These methods are costly and are labor intensive. Thermal spray coatings formed on piston rings must have excellent wear and scuffing resistance. The rings must also minimally wear the liner surface under severe use conditions.

For at least these reasons, an unmet need remains for improved systems, methods, compositions, and apparatus for creating wear-resistant articles that are more economical, have shorter cycle time and are capable of producing layers of coating materials that are not limited in thickness.

### BRIEF DESCRIPTION OF THE DRAWINGS

The various features of the embodiments illustrated and described with reference to any one of the figures may be combined with features illustrated in one or more other figures, as those of ordinary skill in the art will understand. Alternative embodiments that may not be explicitly illustrated or described may be able to be produced. The combinations of features illustrated provide representative embodiments for typical applications. However, various combinations and modifications of the features consistent with the teachings of the present disclosure may be desired for particular applications or implementations.

FIG. 1 is a diagrammatic cross-sectional view of an exemplary piston ring 1 with a groove 3. The groove 3 is present around the entire periphery of the piston ring and comprises a titanium nitride ceramic coating material of a preferred embodiment.

FIG. 2 is a diagrammatic cross-sectional view of an exemplary piston ring 1 without a groove. An exemplary titanium nitride ceramic coating 6 applied around the entire periphery of the piston ring.

FIG. 3 is a diagrammatic cross-sectional view of an exemplary ceramic titanium nitride core particle 8 according to some embodiments.

FIG. 4 is a diagrammatic cross-sectional view of an exemplary titanium nitride particle 8 according some embodiments wherein the core particle 8 has been coated with a metal 9.

### DETAILED DESCRIPTION

Without limitation to only those embodiments expressly disclosed herein and without disclaiming any embodiments, some embodiments of the invention comprise methods, systems, compositions, and apparatus having a thermally sprayed powder coating containing titanium-nitride ceramic particles encapsulated in one of several pure metals or metallic alloys. The powder is useful for producing a high wear-resistant coating on the contacting friction surfaces of machined component parts including, piston rings, piston connecting rods and cylinder liners.

Some embodiments comprise a method for thermal spraying a titanium nitride coating material onto an article. The coating material, wear-resistant titanium nitride (TiN), may be in powder form before the thermal spraying onto the article. In one aspect, thermal spraying includes melting the coating material, propelling the molten coating material toward the article, and coating the article with the molten coating material. In another aspect, the coated article is one or more piston rings. The powder includes a titanium-nitride particle completely encapsulated in a pure metal or metal alloy. The coating exhibits improved corrosion resistance, improved wear, scuffing and spalling resistance. The coating can be used, as nonlimiting examples, in piston ring applications and other direct contact, wear-prone surfaces.

Some embodiments relate to a two-component powder applied via a thermal spray application to reduce frictional wear of a substrate, as nonlimiting examples, of internal combustion engine components, specifically, piston rings. A method for producing and applying such a coating via a thermal spray method is an element of some embodiments. Coating a piston ring with titanium nitride increases the wear and scuff resistance of the piston ring face. Before the thermal spray application, the titanium nitride exists as a two-phase powder comprised of ceramic titanium-nitride particles completely encapsulated in a pure metal or metal alloy. The first phase is comprised of the titanium-nitride ceramic particles. The second phase is the metal that encapsulates the titanium nitride ceramic. After thermal spray application, the two phases combine into a single hardened ceramic-metal matrix which coats the part. The coating as applied exhibits excellent wear resistance and scuffing resistance on metallic substrates subjected to severe frictional forces, specifically frictional forces like those present in internal combustion engines, compressors, and the like.

Some embodiments relate to a method including thermal spraying a titanium nitride powder that coats a surface of a piston ring. In some embodiments, the thermal spray process includes melting the two phase powder, propelling the molten coating material onto the piston ring, and coating the article with the molten coating material.

Some embodiments comprise the use of a plasma spray system to deposit the titanium nitride coating onto the face of the piston ring.

The inventors have found unexpectedly that it is possible to form a uniform thermal spray coating having a fine microstructure: (a) by thermally spraying a powder comprising titanium nitride particles having desired particle sizes encapsulated in a pure Ni, or Ni—X alloy and Ni, as main components, or (b) by thermally spraying a combination of such powder and another desired metal or alloy powder; and that a piston ring having such a thermal spray coating have excellent wear, scuffing and spalling resistance and being compatible to the mating cylinder bore surface.

Thus, the thermal spray coating of some embodiments comprises titanium nitride particles having a particle size between 5 to 60 microns and a coating composed of a metal composed of pure Ni, or a Ni—X alloy and Ni.

The piston ring of some embodiments comprises the above first thermal spray coating at least on an outer peripheral surface. Accordingly, the piston ring of some embodiments has a thermal spray coating formed at least on an outer peripheral surface, the thermal spray coating comprising a first phase of titanium nitride and a second phase of an encapsulating metal composed of pure Ni or other pure metals such as Co, Cr, Mo, Cu, Fe and W, and/or an alloy containing the metal, the first phase existing more than the second phase.

The method for producing a piston ring having the first thermal spray coating of some embodiments comprises thermally spraying an encapsulated powder of titanium nitride onto an outer peripheral surface of the piston ring.

The thermal spray method used in some embodiments is preferably a high-velocity oxygen fuel (“HVOF”) spraying method. There are alternative methods of thermal spray that could be used.

The coating material may have a base or core of any metal, alloy, compound or composition that is suitable for application by thermal spraying. Suitable encapsulating metals include, but are not limited to, Ni, Co, Cr, Mo, Nb, Cu, Fe and W, and/or alloys thereof. Preferred core ceramics include those that combine metals with non-metals. In one aspect, compounds that combine nitride are preferred bases of the coating material. The most preferred core material of this aspect is titanium nitride compound (TiN). Preferred core compositions include those that combine two different metal/non-metal compounds into one composition. In this aspect, preferred core compositions combine titanium and nitrogen. The base core material may be present in amounts of 50-90 wt % of the coating material, with the balance being comprised of any of the encapsulating components.

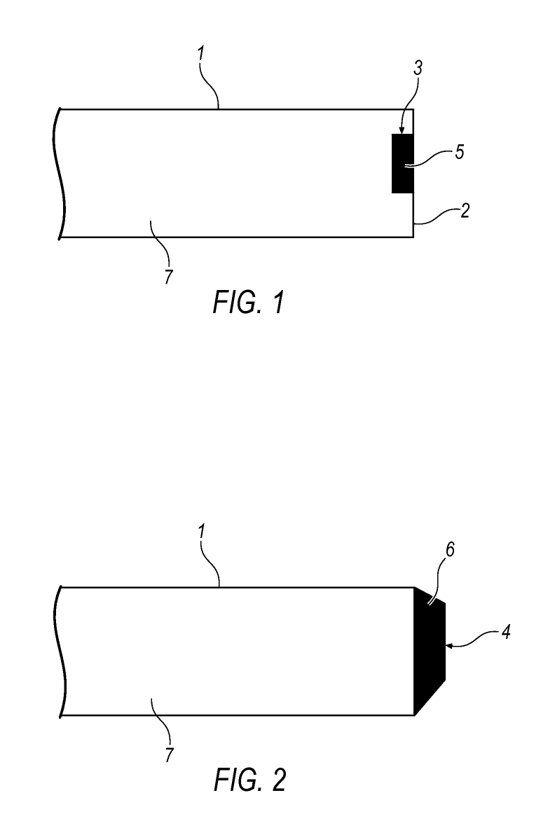

The size, shape and composition of the article are not critical to some embodiments. One preferred article is a piston ring, as seen in FIGS. 1 and 2. Piston ring FIGS. 1 and 2 has an outer surface that includes an outer peripheral face 2 and 4. In use, outer peripheral face 2 and 4 contacts an inner wall of a cylinder (not shown).

The disclosed coating materials may be thermal sprayed onto an article. Thermal spraying is a process that deposits a coating onto an article and includes propelling a thermally softened coating material to the article. Specifically, in a heat source the coating material becomes thermally softened. The thermally softened coating material is carried in a gas stream to the article to be coated where the coating material contacts the article. The thermally softened coating material typically has a particle size in the range of 10-60 microns.

Thermal spray is commonly used to apply coatings. The coating cycle time is relatively short, meaning that more articles may be coated quicker. Thermal spraying also allows coating materials to be applied evenly over the entire article. The preferred as sprayed coating thicknesses are in the range of 100-250 microns to achieve a final coating thickness of 50-200 microns. Such a high level of thickness allows the article to be processed after coating without risking the overall integrity of the coating material. For example, the article may be, honed, ground or lapped after the spray process.

In a gas combustion/powder process, the coating material, in the form of a powder, is aspirated into a fuel and oxygen flame. The thermally softened coating material is propelled to the article by the hot gases, i.e., the aspirating gas and the by-product gases of combustion.

One preferred process is a high-velocity oxy-fuel (HVOF) process. The blended powder, comprised of: about 40 wt. % to about 95 wt. % of a titanium nitride ceramic phase; about 5 wt. % to about 60 wt. % nickel metal and/or nickel metal alloy, is applied to the radial periphery of a stack of piston rings. A Praxair/Tafa JP5000 HP/HVOF (high pressure/high velocity oxygen fuel) thermal sprayer is used to apply the TiN coating to the piston rings. Operating parameters for the HVOF system are listed in Table 1.

TABLE 1
HVOF Operating Parameters Parameter Setting or Measured Value

| | | |
|---|---|---|
| Fuel Flow Rate | 48-52 | psi |
| Carrier Gas Pressure | 5.5-6.5 | gallons/hour |
| Carrier Gas Flow | 23-27 | scfh |
| Powder Feed Rate | 78-82 | grams/minute |
| Surface Speed¹ | 1200 | inches/minute minimum |
| Barrel Length | 8 | inches |
| Standoff Distance | 14-16 | inches |

(Notes: 1. Piston ring circumference times arbor rotation rate.)

Furthermore, as used in this application, the chemical formulae are to be construed broadly. These words and abbreviations encompass a wide range compounds, the ratio of component atoms are not necessarily one to one. For example, TiN may denote Ti₁N₁ as well as Ti₂N₁. Indeed, any ratio of component atoms may be used.

### EXAMPLES

The following examples of some embodiments are provided without limiting the invention to only those embodiments described herein and without disclaiming or waiving any embodiments or subject matter:

FIG. 1 shows a grooved piston ring 1 where an exemplary coating 5 is applied in the groove 1, and FIG. 2 shows a full-face piston ring 1, to which an exemplary coating 6 is applied. In both cases, the piston ring 1 comprises a substrate 7 made of cast iron or steel, and a thermal spray coating 5 or 6 is formed at least on an outer peripheral surface of the substrate. In the case of the grooved piston ring 1 of FIG. 1, a thermal spray coating 5 having wear resistance is formed in a groove 3 of the substrate on its outer peripheral surface 2. In the case of the full-face piston ring 1 of FIG. 2, an outer peripheral surface 4 of the substrate 7 is coated with the thermal spray coating 6 having wear resistance. Although the thermal spray coating as illustrated is formed on the peripheral mating surface of the piston ring, it may be formed on other portions depending on purposes.

The substrate 7 of piston ring 1 is preferably made of materials having good durability. The preferred materials include steels such as carbon steel, low-alloy steel, martensitic stainless steel, etc., or cast irons such as spheroid graphite cast iron, etc.

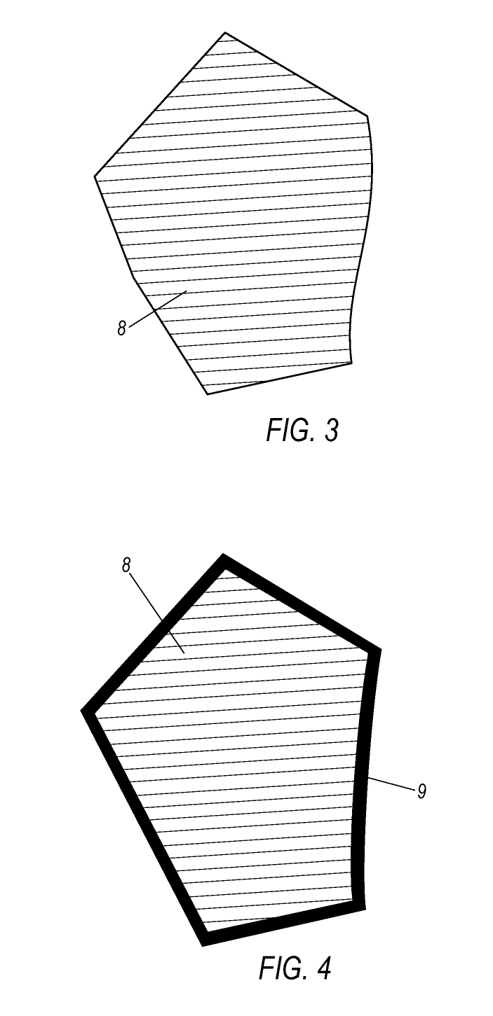

FIG. 3 is a diagrammatic cross-sectional view of an exemplary ceramic titanium nitride core particle 8 according to some embodiments. As illustrated in FIG. 4, an exemplary composition of the thermal spray coating may comprise TiN particles 8 and an encapsulating metal 9 composed of pure Ni, or a Ni—X alloy and pure Ni.

The first thermal spray coating comprises titanium nitride particles. Because the titanium nitride particles have hardness suitable for said piston ring, the thermal spray coating containing titanium nitride particles has excellent wear resistance and scuffing resistance with minimal wear on said ring.

The first phase of the thermal spray powder comprises titanium nitride particles. The content of the TiN particles in this first phase is preferably 30% to 90% by weight.

Metals in the second phase are preferably Fe, Mo, Ni, Co, Cr, Cu, or alloys of these metals. Powders of Fe, Mo, Ni, Co, Cr, Cu or alloys thereof are softened and strongly adhered to the first phase when thermally sprayed. The metals and/or alloys of the second phase encapsulate the titanium nitride particles of the first phase.

A piston ring, on which a thermal spray coating is formed, may be subjected to a pretreatment, if necessary. For instance, a piston ring substrate may be subjected to a surface treatment such as a nitriding treatment, etc. Also, to improve the adhesion of the piston ring substrate to a thermal spray coating, the piston ring substrate may be grit blasted or etched to increase surface roughness and improve adhesiveness of the coating to the substrate. This surface enables a thermal spray material impinging on projections to adhere by mechanical bonding.

In a nonlimiting preferred embodiment, the thermal spray coating is formed by a powder comprising a titanium nitride alloy completely encapsulated in Ni or a Ni—X alloy and pure Ni components being strongly and stably bonded to each other. The chemically stable, strong bonding between titanium nitride alloy and Ni is preferable to prevent oxidation and decomposition of the titanium nitride alloy.

In an additional nonlimiting embodiment, the powder for the thermal spray coating is a mixed powder comprising powder having titanium nitride alloy and Ni, or least one metal selected from the group consisting of Fe, Mo, Ni, Cr and Co, and/or an alloy containing the metal. This powder may be the same as the powder used for the first thermal spray coating.

To enhance wear resistance and scuffing resistance while reducing wear on a mating member, it is necessary to form the thermal spray coating without making it coarser than the starting powder. Preferred thermal spraying methods are high-velocity flame spraying methods such as a high-velocity oxygen fuel (HVOF) spraying method, a high-velocity air fuel (HVAF) spraying method, etc. Among them, the high-velocity oxygen fuel spraying method is particularly preferable.

After final machining, the thermal spray coating thickness remaining on an outer peripheral surface of the piston ring is usually 50 to 200 microns. With a thermal spray coating less than 30 microns thick, the piston ring may fail prematurely. In the piston ring application, a thermal spray coating exceeding 200 microns is not cost effective and in most cases does nothing to enhance or extend the life of the piston ring.

After the formation of the thermal spray coating, the piston ring is machined to a predetermined size and profile. For instance, the outer peripheral surface of the piston ring is preferably ground by a grinding wheel of high-purity, abrasive grains and may be finally lapped by abrasive material

While some embodiments have been specifically described in connection with piston rings, it is to be understood that this is by way of illustration and not of limitation. The scope of the appended claims should be construed to cover any article, whether metal or otherwise, that may benefit from a coating that increases wear resistance. Further, the appended claims should be construed as broadly as the prior art will permit.

What is claimed is:

1. A method of producing a wear-resistant coating for protecting a surface, comprising application of said wear-resistant coating by thermal spray deposition of a powder to a surface, said powder comprised of particles of about 40 wt. % to about 95 wt. % of a titanium nitride ceramic phase and about 5 wt. % to about 60 wt. % nickel metal and/or nickel metal and nickel metal alloy.

2. The method of claim 1, wherein said powder is comprised of ceramic core material/metal encapsulated particles having an average particle size of 10 to 60 microns.

3. The method of claim 2, including the step of accelerating, heating and depositing said particles by a thermal spray process.

4. The method of claim 1, where the coating is comprised of said ceramic core material and encapsulation metal materials.

5. The method of claim 1, wherein said powder contains ceramic materials comprising titanium nitride particles having an average particle size of 5 to 50 microns.

6. The method of claim 1, wherein said particles comprise an encapsulation metal comprising Ni or a Ni—X alloy.

7. The method of claim 1, wherein said particles comprise an encapsulation metal having a single metal or alloy from the following group: Fe, Mo, Co, Cr, Cu, Nb and W.

8. The method of claim 1, wherein said combined material substantially contains said ceramic and said encapsulation metal.

9. The method of claim 1, wherein said particles comprise an encapsulation metal of 5 weight %-60 weight % metal or metal alloy.

10. The method of claim 1, wherein said particles comprise 40 weight %-95 weight % ceramic core material.

11. The method of claim 1, further comprising the step of applying said thermal spray of ceramic core material and said encapsulation metal to form a ceramic rich applied layer to the said substrate.

12. The method of claim 1, further comprising the step of bonding said heterogeneous thermal spray to said substrate.
